(19) United States
(12) Patent Application Publication
(10) Pub. No.: US 2003/0196211 A1
(43) Pub. Date: Oct. 16, 2003

(54) Systems, methods and apparatuses for simulated rapid tuning of digital video channels

(76) Inventor: Peter Chan, Lawrenceville, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/119,700

(22) Filed: Apr. 10, 2002

(51) Int. Cl. H04N 7/173

(52) U.S. Cl. 725/131; 725/139; 725/151

(57) ABSTRACT

A STB utilizing multiple decoders to provide a subscriber with reduced resolution video pictures of a subscriber-requested channel from one decoder while a second decoder buffers and decodes the requested full resolution channel. The STB requires multiple decoders for simultaneously receiving and decoding data received over transmission channels, where at least one of these transmission channels transmits a condensed data stream having video and audio data representing all television channels that the subscriber may select for viewing. The STB leverages the use of this concurrently tuned condensed data stream such that the portion of the condensed data stream representing the requested television channel can be presented during a subscriber perceived delay when a separate decoder within the STB is receiving and decoding the full resolution version of the selected channel.

### FIELD OF THE INVENTION

The present invention relates generally to cable television systems, and more particularly, to cable television systems supporting digital services.

### BACKGROUND OF THE INVENTION

Over the past twenty years there has been a substantial increase in the quantity of programming available to television viewers. In a typical American household, it is not uncommon for viewers to have available fifty or more television stations, and in some cases viewers have more than one hundred channels to choose from. Typically, the high number of channels often makes it difficult for viewers to efficiently locate any single program. Furthermore, due to the ever increasing number of channels and programs at the fingertips of the television viewer, viewers often have difficulty in deciding what station or program to watch. For instance, although a viewer may locate an interesting program, the viewer may still spend a considerable amount of time navigating the remaining channels to confirm that there isn't a more desirable program selection.

The high quantity of programming typically results in channel surfing, which viewers use as a method to quickly ascertain what is being shown on each channel. There are a number of aids to help television viewers with program selection. For instance, with the advent of digital broadcast systems, such as satellite systems and digital cable set-top systems, subscribers are typically offered interactive menus that allow provide subscribers information regarding programming which is currently being aired and programming which is to be aired in the near future. Using these systems, subscribers can access a program guide that allows subscribers to interactively scroll through available programming, usually based on times and channels. Furthermore, subscribers can view details regarding programs scheduled to be aired at a specific time on a specific channel in the near future, such as the length of the program, a program summary, the program players or hosts, the program's rating, as well as other additional data.

Unfortunately, whether channel surfing or viewing program information from a program guide, subscribers of current digital systems experience delay when scrolling through channels or seeking program information. It may, for instance, take a subscriber 30 seconds to scroll through 30 channels. This result stems from the fact that normal MPEG encoded digital video channels suffer from long initial decoding time, which can typically result in a subscriber waiting a second or more before a channel is displayed. This delay is associated with MPEG data buffering prior to decoding and displaying the MPEG video images. The time at which the STB decrypts and decodes the data is typically referred to as the data eclipse period. During this period a typical set-top can either maintain and display the frozen last valid video frame or simply display a black screen.

What is needed is a system, method and apparatus that minimizes this delay so as to allow subscribers to select and immediately view a channel or program information with minimal delay.

### SUMMARY OF THE INVENTION

Systems, methods and apparatuses of the present invention allow a set-top box (STB) user to experience rapid channel changes on digital channels. More specifically, a multiple decoder STB of the present invention provides substitute video and audio data from a constantly tuned condensed data stream during the period of delay due to data buffering and decoding normally encountered by a user after a request to change channels. The condensed data stream provides reduced resolution video and audio of a requested channel while the full resolution video and audio for the requested channel is being buffered and decoded. After the full scale and resolution video is available, the STB seamlessly switches to the full resolution video available from a different tuner. The present invention can work on any digital channels on the cable plant, and is based on a broadcast system rather than an interactive system. Furthermore, because the present invention can be used in a broadcast system, the present invention is easily scalable to support a large population of STBs.

According to one embodiment of the present invention, there is disclosed a digital set-top box (STB) for minimizing subscriber-perceived digital video channel tuning delay. The STB includes a first decoder that continuously decodes a condensed data stream that includes reduced resolution data associated with a plurality of television channels. The STB also includes a second decoder, and a simulated rapid tuning logic in communication with the first decoder and the second decoder. The simulated rapid tuning logic instructs the STB to display at least a portion of the reduced resolution data associated with a television channel while the second decoder decodes full resolution data associated with the television channel.

According to one aspect of the invention, the simulated rapid tuning logic instructs said first decoder to generate a reduced resolution display of the television channel after receiving a subscriber request for the television channel. According to another aspect of the invention, the simulated rapid tuning logic continuously displays video images associated with the first decoder or the second decoder. According to yet another aspect of the invention, the simulated rapid tuning logic instructs the STB to display video generated by said second decoder after said second decoder indicates it is prepared to display full resolution data associated with the television channel. Additionally, the digital STB of the present invention can include a first decoder that receives the condensed data stream, and a second decoder that receives full resolution data associated with the television channel.

According to another embodiment of the present invention, there is disclosed a method executed in digital set-top box (STB) having at least two decoders. The method includes the steps of receiving a request from a subscriber to view a first television channel, and displaying a reduced resolution version of the first television channel while said STB decodes at a first STB decoder full resolution data associated with the first television channel.

According to one aspect of the invention, the method further includes the step of receiving at the STB a condensed data stream, where the condensed data stream comprises reduced resolution data associated with a plurality of television channels, and where the plurality of television channels comprises the first television channel. According to another aspect of the invention, the method further includes the step of continuously decoding the condensed data stream at a second STB decoder.

The method can also include the step of extracting from the condensed data stream a reduced resolution version of the first television channel. Furthermore, the method can further comprise the step of displaying said reduced resolution version of the first television channel while the first STB decoder decodes full resolution data associated with the first television channel.

According to yet another aspect of the invention, the method further includes the step of transitioning from displaying the reduced resolution version of the first television channel to displaying a full resolution version of the first television channel generated by the first STB decoder when the first STB decoder is prepared to display the full resolution version of the first television channel. According to another aspect of the invention, the step of transitioning comprises the step of predicting a future output of the first STB decoder such that the transition is seamless. The step of transitioning may also be executed at a presentation transition point. Moreover, the first STB decoder can decode the first television channel at a constant rate, and the second STB decoder can continue to decode the condensed data stream after the transitioning step occurs.

### BRIEF DESCRIPTION OF THE DRAWINGS

Having thus described the invention in general terms, reference will now be made to the accompanying drawings, which are not necessarily drawn to scale, and wherein:

FIG. 1 shows a block diagram of a conventional Digital Broadband Delivery System (DBDS) including a conventional STB, according to the prior art.

FIG. 2 is a block diagram flow chart depicting the digital channel tuning process for a conventional STB having a single tuner and decoder, according to the prior art.

FIG. 3 shows input channels supported by a DBDS and input into a STB of the present invention, according to the prior art.

FIG. 4 shows a plurality of video pictures presented within multiple frames, according to one aspect of the present invention.

FIG. 5 is a block diagram of the components comprising a STB of the present invention, according to one aspect of the present invention.

FIG. 6 is a block diagram of a simulated rapid tuning process using a STB with at least two decoders for tuning and decoding digital channels, according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

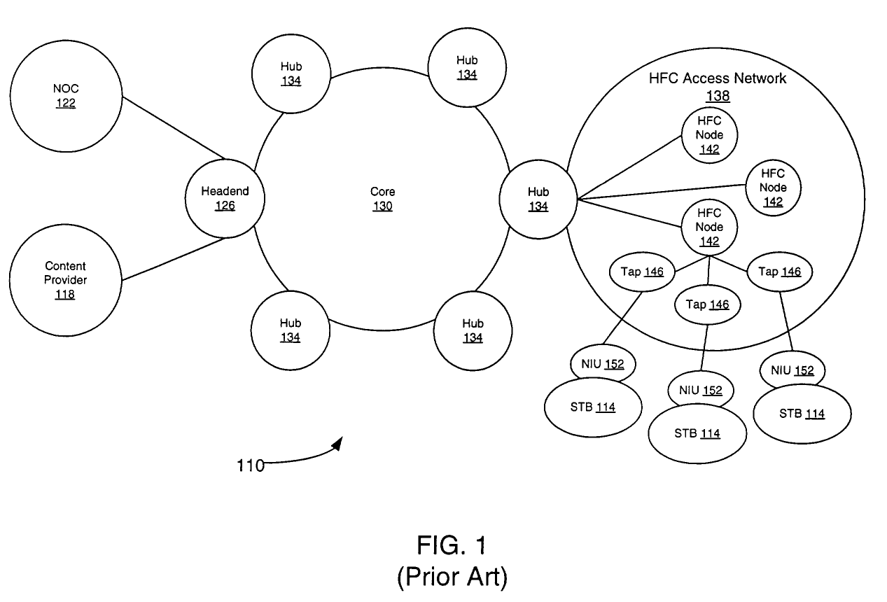

FIG. 1 shows a block diagram view of a Digital Broadband Delivery System (DBDS) 110, including a conventional STB 114, as is well known in the art. Generally, the DBDS 110 is an integrated network system that features video, audio, voice and data services to Cable TV subscribers. Although FIG. 1 depicts a high level view of a DBDS including a regional HFC Access Network 138, as will be described below, it should be appreciated that a plurality of DBDSs can tie together a plurality of regional networks into an integrated global network so that Cable TV subscribers can receive content provided from anywhere in the world. The DBDS 110 shown in FIG. 1 delivers broadcast video signals as digitally formatted signals in addition to delivering traditional broadcast analog video signals. Furthermore, the system can support one way broadcast services as well as both one-way data services and two-way media and data services. The two-way operation of the network allows for subscriber interactivity with services, such as Pay-Per-View programming, View-on-Demand programs, and interactive applications, such as Email, Internet connections, and EPG applications.

The DBDS 110 provides the interfaces, network control, transport control, session control, and servers to access content and services, and distributes content and services to Cable TV subscribers. As shown in FIG. 1, a typical DBDS 110 is composed of interfaces to Content Providers 118, Network Operations Centers (NOC) 122, core networks 130 of headends 126, hubs 134, Hybrid Fiber/Coax (HFC) Access Networks 138, and subscribers' STBs 114. It should be appreciated that although single components (e.g., headend 126, core network 130, HFC Access network 138, etc.) are illustrated in FIG. 1, a DBDS 110 can feature a plurality of each of the illustrated components.

The Content Provider 118 represents one or more providers of content, such as video channels, music channels, data channels, video services, audio services and data services. For example, according to one aspect of the invention, the Content Provider 118 could comprise an Electronic Program Guide (EPG) data provider which acts as a data service provider. According to another aspect of the invention, the Content Provider 118 could represent an Internet Service Provider (ISP) providing data to the system to enable subscribers web access or web-enhanced video via the subscriber's television set. The Content Provider 118 transmits the content to a headend 126 for further transmission to subscribers downstream in the network. Also in communication with the headend 126 is a Network Operation Center (NOC) 122, which is an external management center interfaced with the DBDS 110 to allow for the remote operation of the system.

Content provided by the Content Provider 118 is communicated by the Content Provider 118 to one or more headends 126. From those headends 126 the content is then communicated to the core network 130 of hubs 134 and onto a plurality of Hybrid/Fiber Coax (HFC) Access Networks (only one HFC Access Network 138 is illustrated). The HFC Access Network 138 typically comprises a plurality of HFC nodes 142, each which may service a local geographical area. The content provided from the Content Provider 118 is transmitted through the headend 126, hub 134 and HFC Access Network 138 downstream to one or more taps 146 from each one of the HFC nodes 142 of the HFC Access Network 138. The hub 134 connects to the HFC node 142 through the fiber portion of the HFC Access Network 138. Usually, the HFC node 142 connects to a subscriber's STB 114 through coaxial cable in a logical tree configuration, which is where the optical-to-electrical and electrical-to-optical conversations of the HFC network take place. From the HFC node 142 a coaxial drop connects the tap 146 to a Network Interface Units (NIU) 152, which is a network demarcation point physically located on the side of the subscribers' home. The NIU 152 provides a transparent interface between the HFC node 142 and the subscribers' internal wiring. Coaxial cables are preferred in this part of the system because the electrical signals can be easily repeated with RF amplifiers. Typically, six amplifiers or less are located in series between the HFC node 142 and the subscribers' STBs 114. As DBDSs are well known to those of skill in the art, further description of the DBDS 110 of FIG. 1 will not be contained herein.

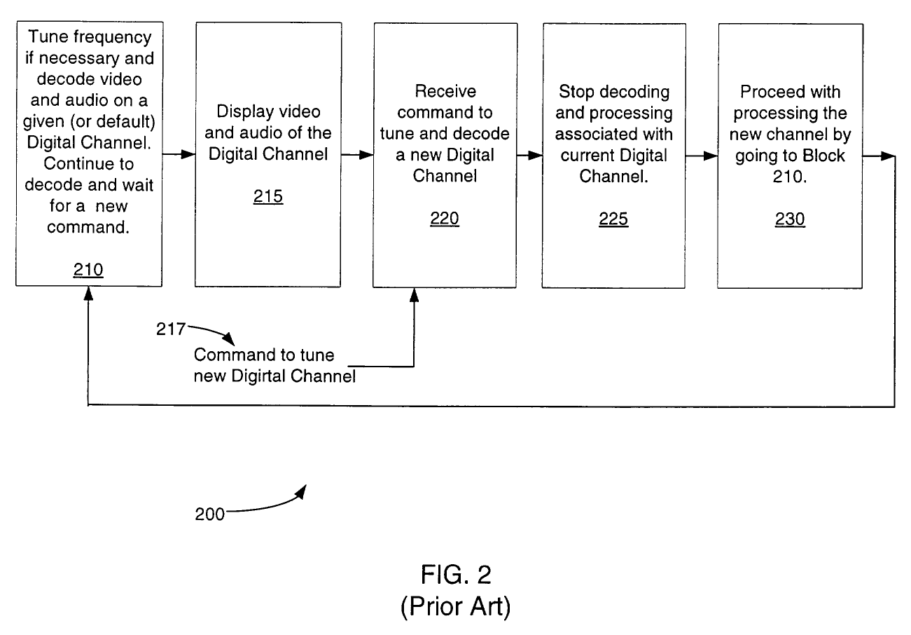

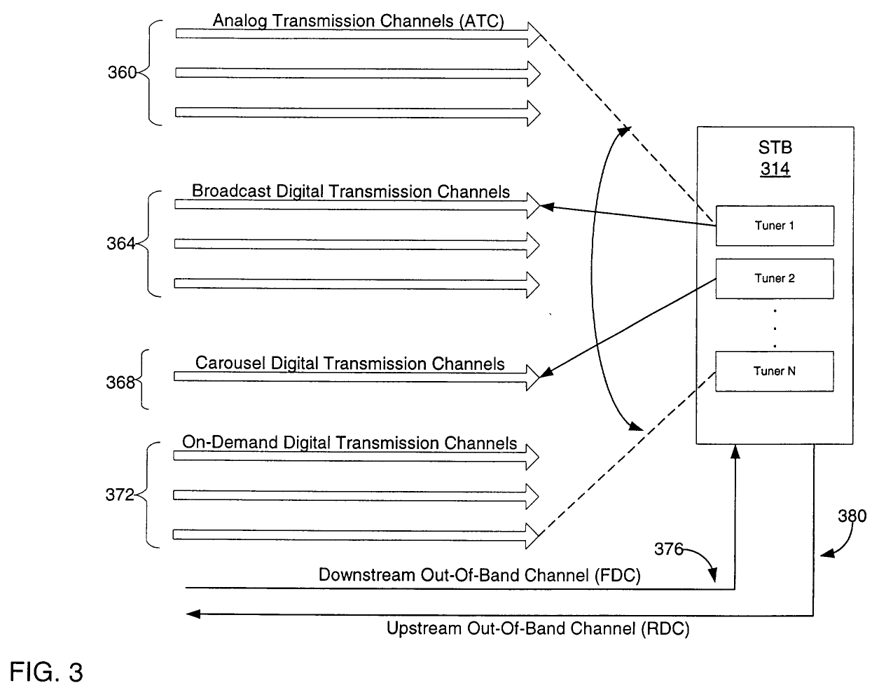

FIG. 2 is a block diagram flow chart depicting the digital channel tuning process for a conventional STB, such as STB 114 of FIG. 1, where the STB 114 includes a single tuner and decoder for tuning and decoding digital channels. It should be appreciated that, as used herein, the term channel tuning describes the process and behavior of a subscriber changing a logical channel, such as a television channel, rather than changing transmission channels described in detail with respect to FIG. 3. Furthermore, it should be appreciated that the process of changing a channel does not necessarily require the STB's 114 tuner to re-tune to a different frequency because unlike analog TV channels, multiple digital channels can exist on the same frequency. Therefore it is possible that tuning to a new frequency is not necessary when a channel is changed.

Referring again to FIG. 2, upon being turned on the STB 114 may typically tune to and decode a digital channel base on default setting , preference of the user(s) or cable service provider, or last tuned channel. Thereafter, the STB 114 will tune to a digital channel based upon a user generated command, such as received from a remote control. When the tuner is on the correct frequency and modulation scheme, the STB 114 decodes the video and audio of the commanded digital channel (block 210). Afterward, the STB 114 continues to decode and displays synchronized audio and video of the presently tuned channel while waiting for further command (block 215). The STB 114 remains in this state until it receives a new command 217 to perform a channel change to a new digital channel (block 220). Upon receiving a command to tune to a new digital channel 217, the STB 114 stops the decoding process for the currently tuned digital channel (block 225). Next, the STB 114 tunes to and decodes the new digital channel requested by a subscriber (blocks 230, 210).

It will be appreciated that the process illustrated in FIG. 2 typically results in a delay between the time the subscriber requests a new digital channel and the time the new digital channel is presented to the subscriber. This delay is associated with MPEG data buffering and decoding prior to displaying the MPEG video images. The delay resulting from the decryption and decoding of data is typically referred to as the data eclipse period. During this period a typical STB 114 can either maintain and display the frozen last valid video frame or simply display a black screen.

The present invention utilizes multiple decoders to provide a subscriber with new video pictures during the data eclipse period. The invention utilizes a STB having a plurality of decoders that can simultaneously receive and decode multiple digital channels received by one or more tuners over one or more transmission channels, described next with respect to FIG. 3.

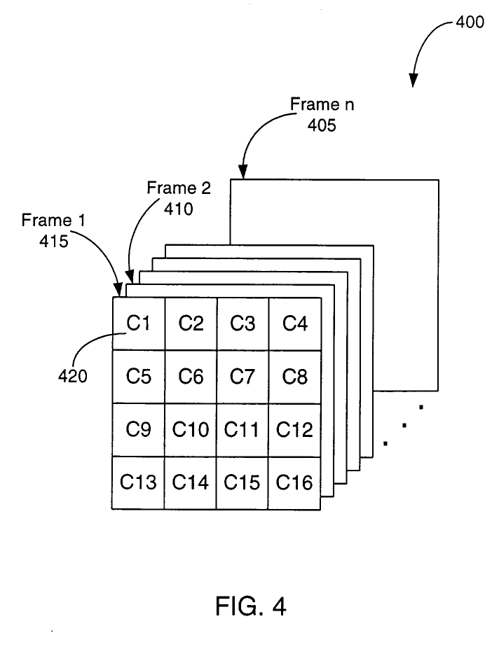

FIG. 3 shows the typical transmission channels supported by the DBDS, where the transmission channels 360, 364, 368, 372 and 376 are capable of being received by a STB 314 of the present invention. As illustrated, the STB 314 of the present invention requires multiple tuners for simultaneously receiving and decoding data received over the transmission channels. As explained in further detail below with reference to FIG. 4, at least one of these transmission channels is received by a dedicated decoder of the STB 314 of the present invention, and is includes video and audio data representing all television channels that the subscriber can select for viewing. The STB 314 of the present invention leverages the use of this continuously decoded condensed data stream such that the portion of the condensed data stream representing the requested television channel can be presented during the data eclipse period while a separate decoder within the STB 314 is decoding a newly selected channel.

Referring again to FIG. 3, the downstream transmission channels 360, 364, 368, 372 and 376 are typically provided by the one or more Content Providers 118 illustrated in FIG. 1. These channels 360, 364, 368, 372 and 376 are typically multiplexed using frequency division multiplexing (FDM), and are often referred to as in-band channels. Analog Transmission Channels (ATCs) 360 and Digital Transmission Channels (DTC) 364, 368, 372 (also known as Digital Transport Channels) carry video, audio and data services. For example, these channels can carry television signals, Internet data, or any additional types of data, such as Electronic Program Guide (EPG) data. The ATCs 360 shown in FIG. 3 are typically broadcast in 6 MHz channels having an analog broadcast composed of analog video and analog audio, and include Broadcast TV Systems Committee (BTSC) stereo and Secondary Audio Program (SAP) audio. Additionally, as will be appreciated by those of skill in the art, additional data, such as EPG data, can be sent with the analog video image in the Vertical Blanking Interval (VBI) of the video signal.

Like the ATCs 360, the DTCs 364, 368, 372 each occupy 6 MHz of the RF spectrum. However, the DTCs 364, 368, 372 are digital channels consisting of 64 or 256-Quadrature Amplitude Modulated (QAM) digital signals formatted as MPEG-2 transport streams, allocated in a separate frequency range. As is well known in the art, the MPEG-2 transport stream enables transmission of a plurality of DTC channel types over each 6 MHz RF spacing, as compared to a 6 MHz ATC. The three types of digital transport channels illustrated in FIG. 3 include broadcast digital transmission channels 364, carousel digital transmission channels 368, and on-demand transmission channels 372. MPEG-2 transport may be used to multiplex video, audio, and data in each of these Digital Transmission Channels (DTCs). However, because MPEG-2 transport stream multiplex video, audio, and data to be placed into the same stream, the DTCs do not necessarily have to be allocated in separate 6 MHz RF frequencies, unlike ATCs 360. On the other hand, each DTC is capable of carrying multiple broadcast digital video programs, multiple cycling data carousels containing broadcast data, and data requested on-demand by the subscriber. Data is formatted, such as in Internet Protocol (IP), mapped into MPEG-2 packets, and inserted into the multiplexed MPEG-2 transport stream.

Each 6 MHz RF spacing assigned as a digital transmission channel can carry the video and audio streams of the programs of multiple television (TV) stations, as well as media and data that is not necessarily related to those TV programs or TV channels, as compared to one TV channel broadcast over one ATC 360 that consumes the entire 6 MHz. The digital data is inserted into MPEG transport streams carried through each 6 MHz channel assigned for digital transmission, and then de-multiplexed at the subscribers' STB so that multiple sets of data can be produced within each tuned 6 MHz frequency span.

Also shown in FIG. 3 is an Out-Of-Band (OOB) channel that provides a continuously available two-way signaling path to the subscribers' STB 314 regardless of which in-band channels are tuned to by the individual STB in-band tuners. The OOB channel consists of a Forward Data Channel (FDC) 376 and a Reverse Data Channel (RDC) 380. The OOB channel can comply to any one of a number of well known transport protocols but preferably complies to either a DAVIC 1.1 Transport Protocol with a FDC of 1.544 Mbps or more using QPSK modulation and an RDC of 1.544 Mbps or more using QPSK modulation, or to a DOCSIS Transport Protocol with a FDC of 27 Mbps using 64-QAM modulation and a RDC of 1.544 Mbps or more using QPSK modulation or 16-QAM modulation. The OOB channels provide the two-way operation of the network, which allows a subscriber interactivity with the applications and services provided by the network. Therefore, functionality reflected in the STB 314 is similar to a networked computer (i.e., a computer without a persistent storage device), in addition to traditional set top box functionality, as is well known in the art. Furthermore, the OOB channels are not limited to a 6 MHz spectrum, but generally to a smaller spectrum, such as 1.5 or 3 MHz.

As will next be described with reference to FIG. 4, the STB 314 of the present invention receives over a dedicated transmission channel a data stream generated by a content provider, where the data stream (hereafter ‘condensed data stream’) includes data representing a plurality of video pictures and corresponding audio associated with a plurality of television channels. Populating one data stream with data corresponding to multiple channels enables a STB 314 in communication with a display device to immediately display one or more of the television channels included within the data stream. However, it will be appreciated that because the condensed data stream is received by one STB 314 tuner over a limited bandwidth, each video picture and audio associated with a particular television channel is of a reduced resolution (lower quality) than that of a full resolution television channel received over a transmission channel. The generation of a condensed data stream having data representing a plurality of television channels is discussed in detail in co-pending U.S. patent application No. 10/080,380 titled “Systems And Methods For Generating A Real-Time Video Program Guide Through Video Access Of Multiple Channels”, assigned to the assignee of the present invention, the entire contents of which are incorporated herein by reference (hereafter the ‘composite presentation application’). According to the present invention, the STB 314 includes at least one decoder dedicated to permanently decoding the condensed data stream such that the STB 314 can immediately display video and audio representing one or more television channels within the condensed data stream during the data eclipse period when the STB 314 is performing MPEG data buffering prior to decoding and displaying the MPEG video images of the newly requested channel. Therefore, during the approximately one second it takes the STB 314 to buffer and decode the requested television channel the subscriber can view a downgraded picture of the requested channel, generated from the condensed data stream. Immediately after the channel is ready to be presented, the STB 314 can switch from the reduced resolution version of the requested channel to the full resolution, high quality version of the channel by switching which decoder is displaying material on the subscriber's display.

FIG. 4 shows program data 400 decoded from a frame-based digitally formatted data stream, where the program data 400 includes plurality of video pictures 420 presented within multiple frames 415, 410, 405. Although not illustrated, each of the video pictures 420 may also have one or more synchronized and associated audio data streams. The program data 400 includes a plurality of frames, frame 1 415 to frame N 405, each of which include multiple video pictures 420. As illustrated, each video picture is associated with a particular television channel. For instance, the video picture located in the upper leftmost portion of frame 1 415 corresponds to television channel 1 (C1), and the video picture in the lower rightmost portion of frame 1 415 corresponds to television channel 16 (C16). Therefore, the program data can include video pictures corresponding to N*X*Y channels, where N is the number of frames, X is the number of columns (of video pictures) per frame, and Y is the number of rows (of video pictures) per frame. Preferably, the program data 400 will be generated in a predetermined order, as shown in FIG. 4, such that the channels will be received in order. However, this is not necessary, as each video picture in the condensed data stream includes identification information specifying the channel or content of the video picture. This can be accomplished based upon a header associated with packets carrying data associated with a particular channel or with specific content, such as MPEG user data fields as are well known in the art. Each video frame has a picture header and zero or more user data fields, which carry frame-related information. Alternatively, a time stamp can be associated with particular data and/or content, where the time stamp aids in the reorganization of program data after its transmission over the DBDS.

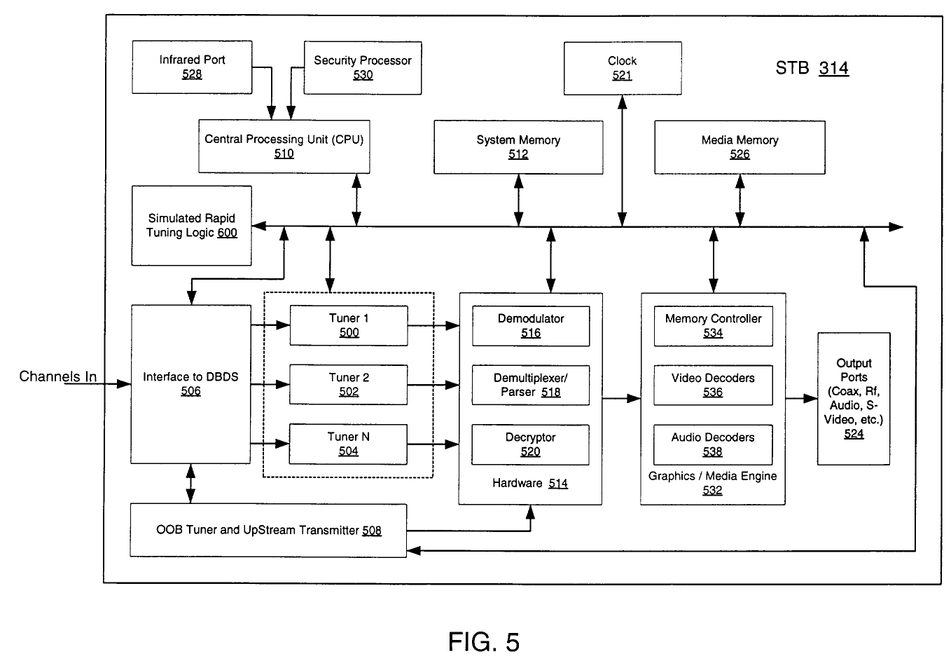

An STB 314 according to the present invention extracts video pictures from the various frames 415, 410, 405 of the condensed data stream to display to a subscriber during the data eclipse period when the STB 314 is responding to a subscriber request to tune to a different television channel. As will be described in greater detail in the composite presentation application, and with reference to FIG. 5, the STB 314 contains software and hardware for extracting from the condensed data stream video and audio data representing a single television channel.

As illustrated in FIG. 5, the STB 314 comprises, according to a preferred embodiment of the invention, a plurality of tuners which can each receive a transmission channels at any given time. Using multiple tuners enables the STB 314 of the present invention to tune to a plurality of downstream services, thereby allowing a subscriber to tune simultaneously to multiple services, including television channels and other media content, transmitted in the downstream via the DBDS. Because conventional STBs contain only one in-band tuner that can tune to one frequency at a time, conventional STBs are limited to receiving data from one frequency, resulting in the inability to tune simultaneously to multiple channels that are on different frequencies.

The present invention utilizes the multiple tuners and decoders within the STB 314 to allow a subscriber to receive at least one full, high quality version of a television channel while at the same time receiving data representing a degraded version of every channel. It will be appreciated, however, that the present invention can be effected using a STB 314 having multiple decoders but only one tuner where the condensed data stream is on the same frequency as the subscriber-selected digital channel. In this situation there is no need for a second tuner since one tuner is only needed to fetch data off a particular frequency. Furthermore, in the case where the condensed data channel is setup on all accessible frequencies, then there is never a need for a second tuner on the STB.

FIG. 5 shows a block diagrams of components comprising the STB 314 of the present invention, according to a preferred embodiment of the present invention. It should be appreciated that the systems and methods of the present invention are described below with reference to block diagrams and flowchart illustrations of systems, methods, apparatuses and computer program products according to embodiments of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Referring again to FIG. 5, the STB 314 of the present invention includes an interface to the DBDS 506 through which the STB 314 receives data from a plurality of analog or digital channels, including analog and digital broadcast TV programs and data, collectively, services, including video, audio and data channels such as DOCSIS cable modem channels. More specifically, because each tuner 500, 502, 504 of the STB 314 can select only one in-band channel at a time, a plurality of tuners are provided so that multiple channels transmitting services can be received simultaneously using the STB 314 of the present invention. Although the STB 314 may be implemented using one or two in-band tuners 500, 502, it may be advantageous to use multiple tuners where a large number of channels are to be displayed simultaneously. The greater the number of tuners included within the STB 314, the greater resources the STB 314 will have to tune to additional channels the STB 314 should the STB be programmed to remain tuned to a particular channel (e.g., a favorite channel) or be programmed to anticipate a channel the subscriber may wish to view next. Preferably, the tuners 500, 502, 504 are capable of receiving signals from an HFC Plant (e.g., an 870 MHz HFC Plant), and each is capable of analog and digital (64/256 QAM) tuning to a single RF channel from a multiplicity of spaced RF channels (e.g., 6 MHz spaced RF channels in the US, 8 MHz in Europe).

Also included within the STB 314 is an Out-of-Band (OOB) tuner and upstream transmitter 508 which is connected to the interface to the DBDS 506. The OOB tuner and upstream transmitter 508 enable the STB 314 to interface with a DBDS network so that the STB 314 can provide upstream data to the network, for example, via a QPSK channel or a QAM channel. In this manner, a subscriber can interact with the DBDS to request services, such as Pay-Per-View programming and View-On-Demand programs and/or comprehensive EPG data for desired programs. It should be appreciated that although the OOB tuner and upstream transmitter are illustrated as one component in FIG. 5, the tuner and transmitter can be independent of each other and located separately within the STB 314, where an OOB 508 and upstream transmitter are separate components of the STB 314. Nonetheless, both components must be in communication with the DBDS so that upstream transmissions can be received by the system. According to one aspect of the invention, a telephone modem in the STB 314 can be utilized for upstream data transmission and a headend 126, hub 134 or other component located upstream in the DBDS can receive data from a telephone network in communication with the telephone modem, where the telephone network routes the upstream data to a destination internal or external to the DBDS, such as a Content Provider.

Referring again to the STB 314 shown in FIG. 5, after the one or more tuners 500, 502, 504 select one or more transmission channels, incoming data is forwarded to hardware 514 comprising circuitry with capability for demodulating 516, demultiplexing and parsing 518, and decrypting 520 the incoming signals. More specifically, the hardware components 514 are capable of QAM demodulation, Forward Error Correction (FER), Parsing MPEG-2 Transport Streams, Packetized Elementary Streams and Elementary Streams, and Decryption, as is well known in the art, to counter the effect of signal processing of broadcast media and data in the DBDS. Particularly, such signal processing is performed at the headend 126 and in some cases it may be performed in part at the hubs 134. Received compressed video streams and audio streams can be deposited continuously into Compressed Audio and Video Buffers of Media Memory 526. Although not illustrated in the embodiment of FIG. 5, additional components can be included within the hardware 514, such as descramblers, decoders, digitizers, signal amplifiers, and other circuitry for signal or error recovery.

One primary component of the STB 314 is the CPU 510, which controls the functions of the STB 314 via a real-time, multi-threaded operating system that enables task scheduling and switching capabilities. More specifically, the CPU 510 operates to execute programs, stored in System Memory 512, under the auspices of the Real-Time Operating System. The CPU 510 may be directed to execute a Watch TV application by a viewer when the viewer presses keys of an remote control, such as an infrared or UHF remote control, associated with the STB 314. Infrared or UHF signals are received through a port 528 in the STB 314. For instance, where a viewer requests to view a particular channel, a Watch TV application executing on CPU 510 will cause the CPU 510 to generate a request message for the particular television channel. This request can be transmitted to an available tuner such that the subscriber can view the requested program.

Also included within the STB 314 is a Graphics/Media Engine 532 which further processes signals for output via output ports 524 to a television set or display. The output ports 524 preferably comprise a RF Channel 3 and 4 output to drive an analog TV or Display or other device such as a VCR, as well as an output video port to drive a display, monitor or TV set that receives an analog TV signal at its input. Additionally, it should be appreciated that the TV or display may be connected to the STB 314 via a video port such as Composite Video, S-Video, or Component Video. The output ports 524 can also comprise Digital Component Video or an IEEE-1 394 interface to drive a TV or Display that receives non-compressed digital TV signals at its input. The Graphics/Media Engine 532 includes components for analog and digital video decoding, as well as analog and digital audio decoding, as are well known in the art. According to one aspect of the present invention, the Graphics/Media Engine 532, with the aid of other elements within the STB 314, as described in the composite presentation application, can extract from the condensed data stream video and audio data representing a single television channel, such as a single picture within one frame of the data stream. Within the Graphics/Media Engine 532, there are one or more Video Decoders 536 and one or more Audio Decoders 538. The Video Decoders 536 can concurrently and independently decode encoded digital video streams. Similarly, the Audio Decoders 538 can concurrently and independently decode encoded digital audio streams.

As shown in FIG. 5, components of the STB 314 also include an analog descrambler and analog video decoder with capability for analog video or audio descrambling, and a security processor 530 working in conjunction with a decryptor 520 to decrypt encrypted digital video, audio or data, as is well known to those of skill in the art. The security processor 530 functions to authorize paying subscriber' STBs to execute specialized features of the STB 314, such as executing the EPG software application and receiving EPG Data.

The STB 314 also includes a Memory Controller 534 and a Media Memory 526. These components can include software and hardware to compose and store graphical information created by the CPU 510. These components enable the compositing of graphical data (e.g., EPG content) with video into a picture for a TV display as provided by capabilities in Graphics/Media Engine 532. Such compositions include graphics data overlayed on video, or downscaled video overlayed onto graphics, or a composition of non-overlapping downscaled motion video pictures and graphic partitions of display.

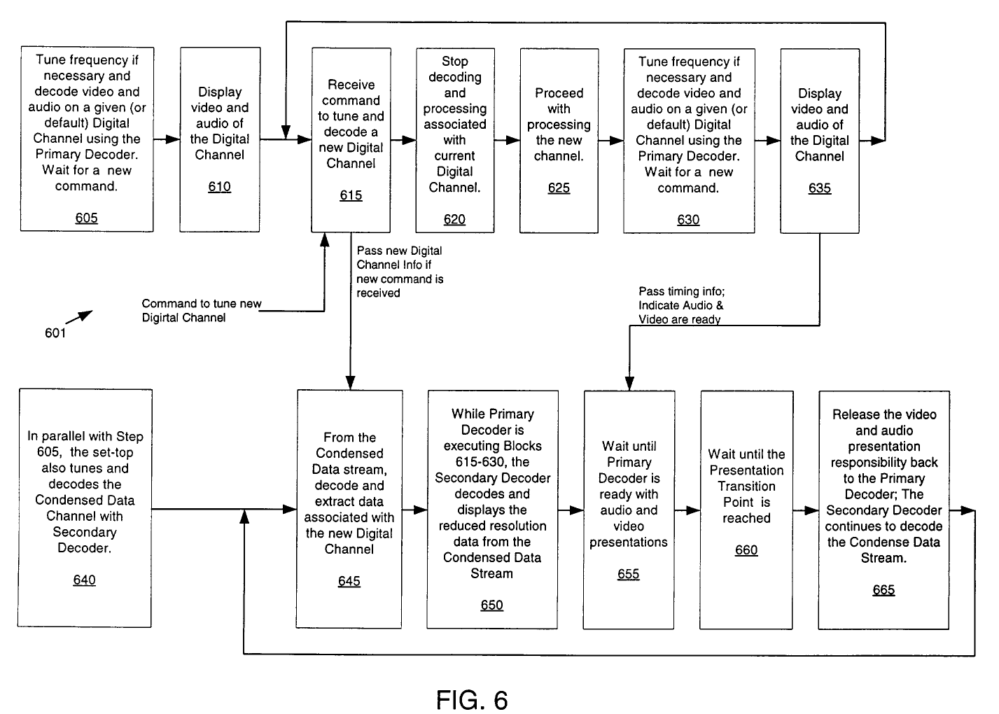

Lastly, FIG. 5 shows a simulated rapid tuning logic 600 within the STB 314. As will be discussed with respect to FIG. 6, the simulated rapid tuning logic 600 leverages the use of the permanently tuned condensed data stream such that the portion of the condensed data stream representing the requested television channel can be presented during a subscriber perceived delay when a separate decoder within the STB 314 is receiving and decoding the full resolution version of the selected channel. After the full resolution version of the selected channel is ready for display, the simulated rapid tuning logic 600 releases responsibility for display of the subscriber selected channel from the decoder decoding the condensed data stream to the decoder decoding the full resolution television channel. As illustrated in FIG. 5, the simulated rapid tuning logic 600 is in communication with hardware and software components within the STB 314, which the simulated rapid tuning logic 600 must query to determine if resources are available to effect simulated rapid tuning.

FIG. 6 is a block diagram of a simulated rapid tuning process 601 using the STB 314 and simulated rapid tuning logic 600 of FIG. 5, according to one embodiment of the present invention. It should be appreciated by those of ordinary skill in the art that FIG. 6 only describes one possible implementation of the simulated rapid tuning logic 600, and that many other implementations are obvious to those of skill in the art given the present description.

FIG. 6 depicts a digital channel tuning process of the present invention where the STB 314 utilizes the video and audio data from the condensed data stream for display while the STB 314 is in the data eclipse period. As used herein, the primary decoder refers to the decoder used to decode a full resolution television program, and the secondary decoder refers to the decoder that decodes a reduced resolution version of the same television program using the condensed data stream. During the period when the primary decoder is not able to present and video and audio data, the secondary decoder can decode and display the reduced resolution set of data from the condensed data stream. Because the secondary decoder is continuously decoding the condensed data stream, there is no timing overhead for data buffering, audio & video synchronization, and frame re-ordering associated with extracting data from the condensed data stream. In essence, the secondary decoder provides a substitution set of video, audio, and data of the desired new channel until the primary decoder is ready with its own presentation.

Blocks 605-635, discussed next, are steps conducted by the primary decoder within the STB 314. First, as explained above with respect to FIG. 3, the process of changing a channel does not necessarily mean the hardware tuner will re-tune to a different frequency. Contrary to analog TV channels, multiple digital channels can exist on the same frequency that normally carries one analog channel. It is possible that tuning to a new frequency is not necessary when a channel is changed. Initially when a user first turns on the STB 314, the STB 314 may decode a particular digital channel based on a default setting, the last tuned channel, or preference of the user(s) or cable service provider. Thereafter, the STB 314 will tune base on the command given by the user. When the tuner is on the correct frequency and modulation scheme, the primary decoder in the STB 314 decodes and displays the video and audio of the commanded digital channel (blocks 605, 610).

The primary decoder in the STB 314 continues to display the synchronized audio and video of a digital channel until it receives a new command to perform a channel change (block 615). Upon receiving a new command, the primary decoder passes channel related information such as frequency, modulation scheme, program ID, and other channel specific information to the secondary decoder. Next, the STB 314 stops the decoding process for the current digital channel (block 620). The STB 314 then proceeds with processing the new digital channel by tuning to a new frequency (if necessary) and decoding video and audio for the subscriber-requested television channel (blocks 625, 630). The primary decoder will then display the video and audio of the requested digital channel (block 635).

Next, blocks 640 through 665 are performed by the secondary decoder within the same STB 314. As stated above, the duty of the secondary decoder is to provide a substitute audio, video, and data presentation during the period the primary decoder is actively trying to decode and display the full resolution digital channel. The secondary decoder starts decoding the condensed data stream immediately after the STB 314 is powered up (block 640). This decoding process is on-going and never stops. Because the process of tuning frequency and buffering the initial data for decoding already have been done, extracting frame information from the condensed data stream in later steps is fast.

After a subscriber inputs a request to tune to a new channel the secondary decoder receives information associated with the selected digital channel from the primary decoder (step 645). Using this information, the secondary decoder can extract and prepare the appropriate frames associated with the digital channel (step 645). The secondary decoder then extracts and prepares the reduced resolution video pictures and audio associated with the digital channel and presents the video pictures to the user. At this point in time, the secondary decoder has control of the display and the subscriber will see and hear the frames associated with the digital channel from the condensed data stream (step 650).

Next, the secondary decoder will continue to display the reduced resolution data representing the requested channel (step 650) until it receives a notification from the primary decoder that indicates the primary decoder has the audio, video, and data presentations ready for the full resolution digital channel (step 655). The notification also carries the timing information for the presentation, which is needed by the secondary decoder to extrapolate a presentation transition point.

To provide seamless transition from the secondary decoder presentation to the primary decoder presentation, it will be appreciated that there must be timing synchronization. In a broadcast environment where the STB 314 has limited resources to buffer broadcast data, strict timing requirements exist within the audio and video stream data. For example, in the MPEG standard, parameters such as a Presentation Time Stamp or Decoder Time Stamp provide an accurate temporal positioning of the data. Similarly, in the MPEG standard, there are jitter restrictions that force these timing information to be accurate. Thus, to effect synchronization between the secondary decoder and the primary decoder these temporal parameters must be synchronized.

Therefore, the secondary decoder can releases the presentation responsibility to the primary decoder when the primary decoder indicates it is ready (step 655) and when the Presentation Time Stamp of the reduced resolution data of the desired new digital channel from the secondary decoder matches the Presentation Time Stamp of the readied presentation from the primary decoder (step 660). Hereafter, this transition is labeled as the Presentation Transition Point. Note that the Presentation Time Stamp of the reduced resolution data of the desired new Digital Channel from the secondary decoder is not the Presentation Time Stamp of the condensed data stream. Rather, the Presentation Time Stamp of the reduced resolution data of the desired new Digital Channel from the secondary decoder is actually the real Presentation Time Stamp embedded in the condensed data stream associated with the particular Digital Channel.

The secondary decoder must extrapolate a Presentation Transition Point before transition is made between the reduced resolution display and the full resolution display. At this point in time, the secondary decoder still has the audio, video, and data presentation responsibility. The secondary decoder continues to present until the Presentation Point is reached (block 660). It should be further appreciated that the audio and video decoding and presentation logic are independent. The seamless transition process performed for audio and video are also independent. Thus, there is one Presentation Transition Point for video and one for audio. The two transitions must be in close temporal proximity to maintain lip-sync properties. By definition, the Presentation Transition Point is where both the logical presentation time of the primary and secondary decoders are the same. Briefly, the subscriber should experience minimum visual and audile artifacts even though the two decoders are not synchronized in time, and are not displaying the same content at the same time or at the same rate. Thus, to obtain a seamless transition, one of the decoders needs to either speed up or slow down to match the other decoder.

In the embodiment illustrated in FIG. 6, the secondary decoder extrapolates the Presentation Transition Point at which point the secondary decoder can hand off the presentation responsibility to the primary decoder. During a brief period at startup, the primary decoder must decode and display at a constant rate. Given the primary decoder's presentation time and the primary decoder's constant rate, the secondary decoder can predict the whereabouts of the primary decoder's presentation of a future time. By knowing how fast the secondary decoder can speed up or slow down, the secondary decoder can extrapolate an intercept course to achieve a seamless transition. By repeating or dropping frames, by decoding a known fixed material (i.e. the condensed data stream) the secondary decoder can maneuver itself to the Presentation Transition Point.

Finally, after the Presentation Transition Point is reached the secondary decoder releases the presentation responsibility over to the primary decoder. Because, according to one embodiment of the invention, the secondary decoder's presentation supersedes that of the primary decoder's presentation, the secondary decoder must release the display to allow the primary decoder's presentation to get displayed. The secondary decoder no longer drives the display but it continues to decode the condensed data stream (block 665). The secondary decoder then returns to block 645. Because the control for the display process is dictated by the secondary decoder, the secondary decoder knows when the primary decoder is and is not available. Thus, the secondary decoder drives the display when the primary decoder is not available to display, and it releases the display when it arrives at the Presentation Transition Point. This priority in display eliminates handshaking and communication overhead needed to support the display responsibility transition from one decoder to another.

It will be appreciated that in the embodiment of FIG. 6 the condensed data stream exists only on one frequency. This expectation requires two hardware tuners and two sets of video/audio decoders to handle the subscriber-selected digital channel and the condensed data channel. However, the condensed data stream may be on the same frequency as the subscriber-selected digital channel. In this situation there is no need for a second tuner since one tuner is only needed to fetch data off a particular frequency. Furthermore, in the case where the condensed data channel is setup on all accessible frequencies, then there is never a need for a second tuner on the STB 314. According to another embodiment of the invention, additional STB tuners and/or decoders may be used to handle a larger condensed data stream. That is, if the condensed data stream covers multiple frequency and MPEG transport streams, additional tuners and decoders could be use to process this stream. This would allow for a higher quality reduced resolution display from the secondary decoder while the primary decoder is tuning, buffering, and decoding a full resolution version of the same digital television channel.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A digital set-top box (STB) for minimizing subscriber-perceived digital video channel tuning delay, comprising:
a first decoder, wherein said first decoder continuously decodes a condensed data stream, and wherein said condensed data stream comprises reduced resolution data associated with a plurality of television channels;
a second decoder; and
a simulated rapid tuning logic in communication with said first decoder and said second decoder, wherein said simulated rapid tuning logic instructs said STB to display at least a portion of said reduced resolution data associated with one of said plurality of television channels while said second decoder decodes full resolution data associated with said one of said plurality of television channels.

2. The digital STB of claim 1, wherein said simulated rapid tuning logic instructs said first decoder to generate a reduced resolution display of said one of said plurality of television channels after receiving a subscriber request for said one of said plurality of television channels.

3. The digital STB of claim 1, wherein said simulated rapid tuning logic continuously displays video images associated with the first decoder or the second decoder.

4. The digital STB of claim 1, wherein said simulated rapid tuning logic instructs said STB to display video generated by said second decoder after said second decoder indicates it is prepared to display full resolution data associated with said one of said plurality of television channels.

5. The digital STB of claim 1, wherein said STB further comprises a first tuner that receives said condensed data stream.

6. The digital STB of claim 5, wherein said STB further comprises a second tuner that receives full resolution data associated with said one of said plurality of television channels.

7. A method executed in digital set-top box (STB) having at least two decoders, comprising:
receiving a request from a subscriber to view a first television channel; and
displaying a reduced resolution version of said first television channel while said STB decodes at a first STB decoder full resolution data associated with said first television channel.

8. The method of claim 7, further comprising the step of receiving at said STB a condensed data stream, wherein said condensed data stream comprises reduced resolution data associated with a plurality of television channels, and wherein said plurality of television channels comprises said first television channel.

9. The method of claim 8, further comprising the step of continuously decoding said condensed data stream at a second STB decoder.

10. The method of claim 9, further comprising the step of extracting from said condensed data stream a reduced resolution version of said first television channel.

11. The method of claim 10, further comprising the step of displaying said reduced resolution version of said first television channel while said first STB decoder decodes full resolution data associated with said first television channel.

12. The method of claim 11, further comprising the step of transitioning from displaying said reduced resolution version of said first television channel to displaying a full resolution version of said first television channel generated by said first STB decoder when said first STB decoder is prepared to display said full resolution version of said first television channel.

13. The method of claim 12, wherein the step of transitioning comprises the step of predicting a future output of said first STB decoder such that said transition is seamless.

14. The method of claim 12, wherein the step of transitioning is executed at a presentation transition point.

15. The method of claim 12, wherein the first STB decoder decodes said first television channel at a constant rate.

16. The method of claim 12, wherein said second STB decoder continues to decode said condensed data stream after the execution of said transitioning step.
